(19) United States
(12) Patent Application Publication
(10) Pub. No.: US 2022/0177106 A1
(43) Pub. Date: Jun. 9, 2022

(54) AIRSHIP WITH RIGID SUPPORTING STRUCTURE

(71) Applicant: Silvano PASCUCCI, Canale Monterano (IT)

(72) Inventor: Silvano PASCUCCI, Canale Monterano (IT)

(21) Appl. No.: 17/601,209

(22) PCT Filed: Apr. 3, 2020
(86) PCT No.: PCT/IT2020/050087

§ 371 Date: Oct. 4, 2021

(30) Foreign Application Priority Data
Apr. 5, 2019 (IT) 102019000005232

(51) Int. Cl. B64B 1/08; B64B 1/22; B64B 1/30; B64B 1/62

(52) U.S. Cl. CPC B64B 1/08; B64B 1/62; B64B 1/30; B64B 1/22

(57) ABSTRACT

Rigid structural-frame dirigible comprising an internal framework divided in internal zones fixedly clearly separated and sealingly isolated therebetween through rigid partition means in fixed union with the internal frame itself, and suitable for being evacuated to a vacuum regime, respectively forming as many vacuum zones (3A; 3B; 3C).

The present invention refers to a rigid structural-frame dirigible, i.e. airship, having an empty-weight centre of gravity, in an aerodynamic shape with an equilibrium mirror structural symmetry with respect to a longitudinal, vertical plane, passing through said centre of gravity, including an internal framework, and including a plurality of motors and a pressurized pilot's cabin, as in the appended claim 1.

Rigid structural-frame dirigible, i.e. airship, that are able to float in the air thanks to the filling with gas lighter than the air, are already known in the state of the art.

Also, rigid structural-frame dirigibles have a future in the air transportation for they are cheap, simple and environment friendly.

However, all lifting systems are based on the input and output of helium gas, which is notoriously expensive, through processes that are also expensive in terms of power.

All said, the objective of the present invention is to provide a rigid structural-frame dirigible, i.e. airship, which allows substantial savings in the costs of its global performance.

It's an ulterior objective of the present invention to provide a rigid structural-frame dirigible, i.e. airship, which allows substantial energy saving in its global performance.

It's an ulterior objective of the present invention to provide a rigid structural-frame dirigible, i.e. airship, which allows a low grade of air pollution in its global performance.

These objectives are achieved thanks to an internal division in a rigid and stable manner of the dirigible rigid structural-frame in a plurality non-intercommunicating compartments, suitable for being evacuated to a vacuum regime, respectively forming as many vacuum zones (with a vacuum regime). As it is known by Archimede's low, a body immersed in a fluid is buoyed up, i.e. in the same direction but reverse to the force of gravity, by a force equal to the weight of the displaced fluid; in this case, the air in a normal condition, when evacuated, provides an upward thrust equal to 1,2250 kg_{f}/m³, as shown in Table 1 (source: DI LECCE, MICHELE, Fondamenti di Aeronautica (2^{nd} ed.), I.B.N.—Bibliographic Institute Napoleone Editor, Rome (20014)):

TABEL 1
INTERNATIONAL TYPE AIR TABEL

| Altitude | Temperature | Pressure | | Density |
|---|---|---|---|---|
| Z | T | P | | S.T. |
| m | ° C. | mmHg | Kg/m³ | Kg sec²/m⁴ |
| 0 | 15 | 760 | 1.2250 | 0.1249 |
| 500 | 11.75 | 715.9 | 1.1671 | 0.1190 |
| 1000 | 8.50 | 674.1 | 1.1117 | 0.1133 |
| 1500 | 5.25 | 634.2 | 1.0581 | 0.1079 |
| 2000 | 2 | 596.2 | 1.0064 | 0.1026 |
| 2500 | −1.25 | 560.1 | 0.9567 | 0.0975 |
| 3000 | −4.5 | 525.8 | 0.9091 | 0.0927 |
| 3500 | −7.75 | 493.2 | 0.8631 | 0.0880 |
| 4000 | −11 | 462.3 | 0.8190 | 0.0835 |
| 4500 | −14.25 | 432.9 | 0.7767 | 0.0792 |
| 5000 | −17.5 | 405.1 | 0.7360 | 0.0750 |
| 5500 | −20.75 | 378.7 | 0.6969 | 0.0710 |
| 6000 | −24 | 353.7 | 0.6595 | 0.0672 |
| 6500 | −27.25 | 330.2 | 0.6237 | 0.0636 |
| 7000 | −30.5 | 307.9 | 0.5894 | 0.0601 |
| 7500 | −33.75 | 286.8 | 0.5565 | 0.0567 |
| 8000 | −37 | 266.9 | 0.5250 | 0.0535 |
| 8500 | −40.25 | 248.2 | 0.4949 | 0.0504 |
| 9000 | −43.5 | 230.4 | 0.4661 | 0.0475 |
| 9500 | −46.75 | 213.8 | 0.4387 | 0.0447 |
| 10000 | −50 | 198.2 | 0.4125 | 0.0420 |
| 10500 | −53.25 | 183.4 | 0.3875 | 0.0395 |
| 11000 | −56.5 | 169.6 | 0.3637 | 0.0371 |
| 12000 | −56.5 | 144.9 | 0.3107 | 0.0317 |
| 13000 | −56.5 | 123.7 | 0.2653 | 0.0270 |
| 14000 | −56.5 | 105.7 | 0.2266 | 0.0231 |
| 15000 | −56.5 | 90.3 | 0.1936 | 0.0197 |
| 16000 | −56.5 | 77.1 | 0.1653 | 0.0169 |
| 17000 | −56.5 | 65.9 | 0.1412 | 0.0144 |
| 18000 | −56.5 | 56.2 | 0.1206 | 0.0123 |
| 19000 | −56.5 | 48 | 0.1030 | 0.0105 |
| 20000 | −56.5 | 41 | 0.0880 | 0.0090 |

This means that if a body is sufficiently large, an upward thrust can be obtained equal to the total volume weight of the displaced air minus the overall weight of the transported body.

The teaching of this invention consists in the use of vacuum instead of gas lighter than the air or hot air in the airships, which is the sustenance and the equilibrium of the airship through the variation of atmospheric air filling and emptying of said vacuum zones, fixedly clearly separated and sealingly isolated. Said teaching is achievable for a variety of uses and dimensions.

In the state of the art, there is no airship that uses a fix separation between internal isolated areas in an airship where atmospheric air filling and emptying is handled in the way thought by this invention.

The possibility of use with the carrier characterized by the airship of the present invention is very wide and, in the same way, the variety of mechanical and aeronautics characteristics, but also the variety in shape and dimensions that the airship of the present invention can take is also wide.

The rigidity of the airship structure of the present invention allows the use thereof as carrier of both goods and passengers, with on-board staff, as geostationary observation station for remote control phenomena, particularly a plurality of airship forming a communication satellite chain, with launch costs and maintenance well below the current ones.

Therefore, is an objective of the present invention a rigid structural-frame dirigible, i.e. airship, having an empty-weight centre of gravity, in an aerodynamic shape with an equilibrium mirror structural symmetry with respect to a longitudinal, vertical plane (Π3), passing through said centre of gravity, including an internal framework, and including a plurality of motors and a pressurized pilot's cabin, as in the appended independent claim 1.

Forms of preferred embodiment are shown in the dependent claims.

In particular, is provided that said internal framework is made of a light metal, particularly aluminium or alloys thereof.

Flight stability of the airship of the present invention can be guaranteed through a suitable distribution of the vacuum regimens on the inside of the vacuum zones by the thermal power plant.

The advantage of the airship of the present invention, compared to that in the state of the art, which uses helium, consists in being less expensive and easier in the transportation handling of any sort, not being necessary to purchase gas, nor devices for its use.

The present invention will be fully understood based on the following detailed description of a preferred embodiment thereof, which will be given by way of example only, absolutely non limitative, referring to the attached drawings, where,

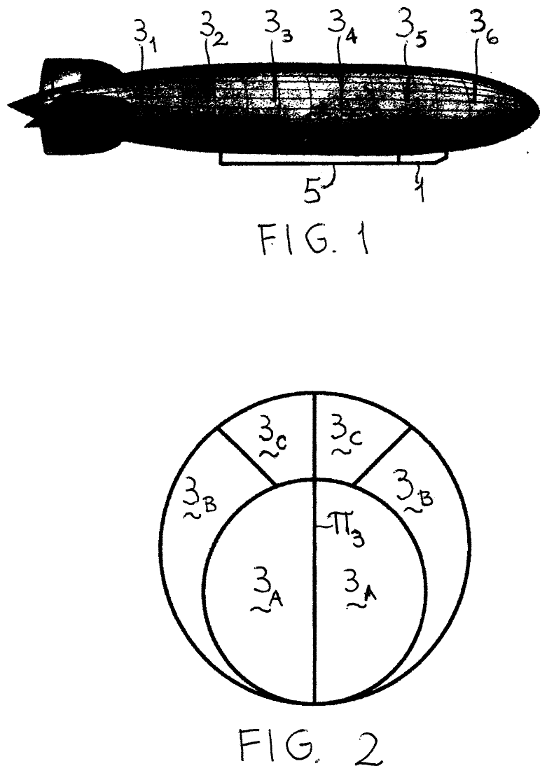

FIG. 1 is a lateral view of a rigid structural-frame dirigible, i.e. airship of the present invention;

FIG. 2 shows a straight cross section of the same.

Referring to FIG. 1, a rigid structural-frame dirigible, i.e. airship is shown, having an empty-weight centre of gravity, exemplified as giant “cigar-shaped” airship, in an aerodynamic shape with an equilibrium mirror structural symmetry with respect to a longitudinal, vertical plane (Π3), passing through said centre of gravity, including an internal framework, and including a plurality of motors and a pressurized pilot's cabin 1. As shown in FIG. 2, the “cigar-shaped” airship exemplified has a structural frame having a circular straight cross section.

Perceptively, said internal framework is subdivided into internal zones, symmetrically with respect to said vertical plane (Π3), respectively forming non-intercommunicating compartments, i.e. internal zones fixedly and clearly separated and sealingly isolated therebetween through rigid partition means in fixed union with the internal frame itself, and suitable for being evacuated to a vacuum regime, respectively forming as many vacuum zones 3_{A}; 3_{B}; 3_{C}.

As shown in FIG. 2, perceptively, the vacuum zones include a perennial vacuum zone (3A) having such a total volume that the upward thrust caused by the evacuation of the same is greater than the vacuum weight of the dirigible itself; a stabilization vacuum zone (3B), of such a volume that air-evacuation or air-filling thereof are suitable to controlling take-off, landing and altitude-keeping of the dirigible itself; a manoeuvre vacuum zone (3C), of such a volume that air-evacuation or air-filling thereof are suitable to controlling actuation of manoeuvre displacements with respect to flight altitude of the dirigible itself. The stabilization vacuum zone (3B) and the manoeuvre vacuum zone (3C) always including a variable sensible air quantity.

As shown in FIG. 2, every airship cross section along the longitudinal plane of symmetry (Π3) is symmetric, both structurally and in terms of airship load, physically mirrored to such plane.

The handling of the vacuum provides that a perennial vacuum (perennial vacuum zone (3_{A}) is always present, which alone balances the empty airship and also part of the load; to that, a stability vacuum (stabilization vacuum zone 3_{B}) is added, which is used during take-off, besides a manoeuvre vacuum (manoeuvre vacuum zone 3_{C}) until a desired flight altitude, such that a minimum quantity of air is always present, depending on the airship type, in both said zones.

The airship of the present invention also comprises ground anchoring means, since the upward thrust given to the perennial vacuum zone is bigger that the airship unladen weight.

The airship of the present invention is equipped with a pneumatic central system which comprises an aspiration and compression system, comprising of pipes afferent to the pneumatic central system itself. The pneumatic central system is in functional connection to the vacuum zones 3_{A}; 3_{B}; 3_{C} for the regulation the vacuum regimen therein in order to generate an upward thrust to an altitude in the atmosphere or a downward negative thrust.

The rigid structural-frame dirigible, i.e. airship of the present invention can also include a cargo-bay forming zone 5.

Desirably, the internal framework is made of a light metal, including aluminium or alloys thereof with an insulating material coating. By “light” metals and alloys thereof is meant, in the present application as in the state of art, metals or alloys thereof having a density inferior to that of ferrous metals and alloys thereof (steel and cast iron). Particularly, is contemplated that the internal framework be made of aluminium or alloys thereof.

Is contemplated that the vacuum zones (3A; 3B; 3C) are subdivided along said vertical symmetry plane (Π3) into non-intercommunicating cross-sectionings (3₁, . . . , 3₆) separated and sealingly isolated therebetween by rigid partition means in fixed union.

Said cross-sectionings by which all the vacuum zones are dived, by the division itself, are suitable to limit the damages in case of accidental air intake, maintaining a balanced attitude of the airship, balancing the thrusts.

For example, in the case of the “cigar-shaped” airship shown in FIG. 1, if the total length of the airship is 270 m, the main cross-section diameter would be 47 m with a volume of 433.000 m³, which correspond to an upward thrust of 530.000 kg_{f} in normal conditions. It's clear that, whichever is the unladen weight, it enables an important saving in the transportation of several tens of good tons. The airship of the present invention is clearly advantageous also for the transportation of passengers.

It's contemplated that the perennial vacuum zone 3_{A} is an internal zone in the main framework of the airship itself, in order to protect it from external damages.

It's contemplated that the stabilization vacuum zone 3_{B} and the manoeuvre vacuum zone 3_{C} are built as individual tanks, connected to the pressurized pilot's cabin 1 and to the cargo-bay forming zone 5.

It's contemplated that the manoeuvre vacuum zone 3_{C} is incorporated in the stabilization vacuum zone 3_{B} in a single vacuum zone.

Advantageously, pipes of the aspiration and compression plant are placed in those dirigible spots exposed to condensation.

It's contemplated that the airship of the present invention also includes emergency means comprising of electric power generation means and means forming emergency line that connect these ones to the pneumatic central system; air compression means; compressed air storage means; means for functional connection with said motors, so that such emergency means allow manual control and piloting of the airship itself with out-of-use electric plants.

It is also contemplated for the pneumatic central system to be functionally connected to said motors.

It is also contemplated for said motors to be tilt motors, including tractor screw propellers, so suitable, when actuated in rotation on a horizontal plane, oriented upwards, both to provide a positive thrust for the ascent to an altitude of the dirigible itself, and to aspirate air from said stabilization vacuum zone 3_{B}, operating themselves as vacuum machines without a further energy expenditure for aspiration of air from said stabilization vacuum zone 3_{B}.

During landing, the pneumatic central system provides air to the stabilization vacuum zone and motors take the air from the outside (when a defined altitude is reached, motors use the external air to function).

The present invention has been described and illustrated referring to specific embodiments thereof, but it should be understood that variations, additions and omissions can be made, without departing from the scope of the invention itself, as defined in the appended claims.

1. Rigid structural-frame dirigible i.e. airship, having an empty-weight centre of gravity, in an aerodynamic shape, having an equilibrium mirror structural symmetry with respect to a longitudinal, vertical plane (Π₃), passing through said centre of gravity, including an internal framework, and including a plurality of motors and a pressurized pilot's cabin (1); characterized in that
said internal framework is subdivided into internal zones, symmetrically with respect to said vertical plane (Π₃), respectively forming non-intercommunicating compartments, i.e. internal zones fixedly clearly separated and sealingly isolated therebetween through rigid partition means in fixed union with the internal frame itself, and suitable for being evacuated to a vacuum regime, respectively forming as many vacuum zones (3_{A}; 3_{B}; 3_{C});
which vacuum zones (3_{A}; 3_{B}; 3_{C}) include a perennial vacuum zone (3_{A}) having such a total volume that the ascent thrust caused by the evacuation of the same is greater than the vacuum weight of the dirigible itself; a stabilization vacuum zone (3_{B}), of such a volume that evacuation or air-filling thereof are suitable to controlling takeoff, landing and altitude-keeping of the dirigible itself; a manoeuvre vacuum zone (3_{C}), of such a volume that evacuation or air-filling thereof are suitable to controlling actuation of manoeuvre displacements with respect to flight altitude of the dirigible itself; said stabilization vacuum zone (3_{B}) and said manoeuvre vacuum zone (3_{C}) always including a sensible air quantity;
and including
ground anchoring means;
a pneumatic central system including an aspiration and compression plant, including afferent pipes in the pneumatic central system itself; which pneumatic central system is in functional connection with said vacuum zones (3_{A}; 3_{B}; 3_{C}) to adjust the vacuum regime inside them to generate an upwards thrust to an altitude in the atmosphere or a downwards negative thrust.

2. Rigid structural-frame dirigible i.e. airship according to claim 1, further including a cargo-bay forming zone (5).

3. Rigid structural-frame dirigible i.e. airship according to claim 1, wherein said internal framework is of a light metal, including aluminum and alloys thereof, with an insulating material coating.

4. Rigid structural-frame dirigible i.e. airship according to claim 1, wherein said vacuum zones (3_{A}; 3_{B}; 3_{C}) are subdivided along said vertical symmetry plane (Π₃) into non-intercommunicating cross-sectionings (3₁, . . . , 3₆) separated and sealingly isolated therebetween by rigid partition means in fixed union.

5. Rigid structural-frame dirigible i.e. airship according to claim 4, wherein said cross-sectionings have a support structure of a light metal, including aluminum and alloys thereof, with an insulating material coating.

6. Rigid structural-frame dirigible i.e. airship according to claim 1, wherein said perennial vacuum zone (3_{A}) is an internal zone in the structural frame of the dirigible itself.

7. Rigid structural-frame dirigible i.e. airship according to claim 1, wherein said perennial vacuum zone (3_{A}), said stabilization vacuum zone (3_{B}) and said manoeuvre vacuum zone (3_{C}) are respectively formed as individual tanks, connected to said pressurized pilot's cabin (1) and to said cargo-bay (5).

8. Rigid structural-frame dirigible i.e. airship according to claim 1, wherein said manoeuvre vacuum zone (3_{C}) is incorporated in said stabilization vacuum zone (3_{B}) in a unitary vacuum zone.

9. Rigid structural-frame dirigible i.e. airship according to claim 1, wherein said pipes of said aspiration and compression plant are arranged in spots of the dirigible itself which are exposed to condensation forming.

10. Rigid structural-frame dirigible i.e. airship according to claim 1, further including emergency means including electric power generation means and means forming emergency line that connect these ones to said pneumatic central system; air compression means; compressed air storage means; means for functional connection with said motors, so that such emergency means allow manual control and piloting of the airship itself with out-of-use electric plants.

11. Rigid structural-frame dirigible i.e. airship according to claim 1, wherein said pneumatic central system is further in functional connection with said motors.

12. Rigid structural-frame dirigible i.e. airship according to claim 11, wherein said motors are tilt motors, including tractor screw propellers, so suitable, when actuated in rotation on a horizontal plane, oriented upwards, both to provide a positive thrust for ascent to an altitude of the dirigible itself, and to aspirate air from said stabilization vacuum zone (3_{B}), operating themselves as vacuum machines without a further energy expenditure for aspiration of air from said stabilization vacuum zone (3_{B}).
